(19) United States
(12) Patent Application Publication
(10) Pub. No.: US 2018/0352065 A1
(43) Pub. Date: Dec. 6, 2018

(54) Keypad Fluid Guard for Inmate Phones

(71) Applicant: Global Tel*Link Corporation, Reston, VA (US)

(72) Inventor: James BOCK, Citrus Heights, CA (US)

(21) Appl. No.: 15/611,421

(22) Filed: Jun. 1, 2017

(51) Int. Cl. H04M 1/18

(52) U.S. Cl. CPC H04M 1/18; H04M 1/0297

(57) ABSTRACT

Disclosed herein is a keypad fluid guard for preventing keypad failure in inmate phones from exposure to fluids. The keypad fluid guard comprises a first portion that extends in a first plane in a direction along a width of a telephone casing of an inmate phone; and a second portion that extends in a second plane in a direction along a length of the telephone casing, wherein the second portion comprises a set of tabs for mounting the first portion of the keypad fluid guard in between a switchhook and a keypad of the inmate phone.

### BACKGROUND

### Field

The disclosure relates to a keypad fluid guard for inmate phones for preventing keypad failure from exposure to fluids.

### Background

In a controlled environment, such as a correctional facility, inmates use telephones to communicate with friends, families, and/or loved ones. In some cases, telephones, such as payphones, at the correctional facility are located outside of the facility or located in areas of the facility where the phones are exposed to various elements, such as dirt, grime, and other elements. Phone conditions deteriorate over time with use and necessitate for the phones to be cleaned or replaced frequently. One or more employees such as guards at the correctional facility clean the phones by using a water hose and one or more cleaning solvents to wash away the dirt and grime of the phones.

However, during cleaning of a telephone, water and/or cleaning solvents leak into the telephone casing through the telephone hook or switchhook, and fluids migrate to the circuit board of the telephone's keypad. Exposure to fluids causes corrosion of elements of the circuit board, such as copper and soldered components, and ultimately results in circuit degradation and keypad failure in the phone. Thus, the keypad for each telephone needs to be replaced, and the correctional facility may have several telephones that are out of service and unavailable for use by inmates. Replacing keypads in thousands of payphones at hundreds of correctional facilities is expensive and may cost the correctional facility millions of dollars. Furthermore, the correctional facility loses potential revenue brought in by each payphone when payphones are out of service due to keypad failure. Accordingly, there is a need for new technologies and components that would prevent keypad failure in inmate phones from exposure to fluids.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1 illustrates a three-dimensional perspective view of an inmate telephone in a correctional facility, according to embodiments of the present disclosure.

FIG. 2 illustrates a three-dimensional perspective view of the telephone casing of an inmate phone with an installed keypad fluid guard, according to embodiments of the present disclosure.

FIG. 3 illustrates a three-dimensional perspective view of the back plate of the inmate phone, according to embodiments of the present disclosure.

FIG. 4 illustrates a plan view of a template for a keypad fluid guard, according to embodiments of the present disclosure.

FIGS. 5A and 5B illustrate side views of a keypad fluid guard in different configurations, according to embodiments of the present disclosure.

FIG. 6 illustrates a three-dimensional perspective view of the telephone casing of an inmate phone with the keypad fluid guard installed in a second configuration, according to embodiments of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Those skilled in the relevant art(s) will recognize that this description may be applicable to many inmate phone models and keypad units without departing from the spirit and scope of the present disclosure.

### Inmate Phone

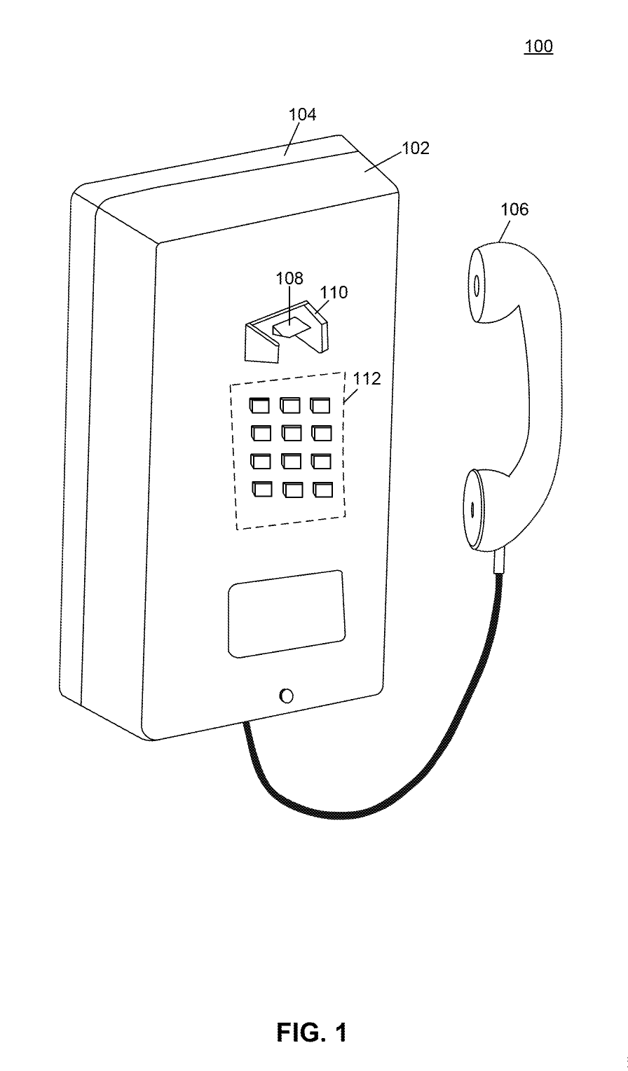

FIG. 1 illustrates a three-dimensional perspective view of an inmate phone 100 in a correctional facility, according to embodiments of the present disclosure. In some embodiments, the inmate phone 100 represents a payphone that is located in a correctional facility. Although only one inmate phone 100 is shown in FIG. 1, it is understood that there can be a plurality of inmate phones 100 in a correctional facility. The inmate phone 100 comprises a telephone casing 102, a back plate 104, and a handset 106. In some embodiments, the back plate 104 of the inmate phone 100 is mounted to a wall or a pole by mounting hardware, and the telephone casing 102 is affixed to the back plate 104 by additional hardware (e.g., screws). The inmate phone 100 further comprises a switchhook 108, a phone cradle 110, and a keypad 112. The switchhook 108 comprises an electrical switch or lever that is located within the phone cradle 110 where the handset 106 is placed when not in use. In some embodiments, the telephone casing 102 of the inmate phone 100 is utilized to cover and protect the switchhook 108, keypad 110, and telephone housing and circuitry of the inmate phone 100.

Inmates in the correctional facility utilize the inmate phone 100 to communicate with friends, families, and/or loved ones during each inmate's sentence at the correctional facility. Each correctional facility has multiple inmate phones 100, which are located outside of the prison, such as in a prison yard or recreation yard, or in a designated area of the facility (e.g., in a hallway or room). When inmate phones 100 are located outside and/or in the designated area, the inmate phones 100 are exposed to conditions that cause the phones to become soiled and collect dirt over time. For example, the inmate phones 100 collect dust, debris, dirt, or other sediments from the external environment (e.g., from the outside or from the facility) over time and with use. Thus, one or more employees such as guards at the correctional facility clean each inmate phone 100 by using a water hose and one or more cleaning solvents to wash away the dirt and grime of the inmate phone 100.

However, during cleaning of the inmate phone 100, water and/or cleaning solvents (e.g., chlorinated solvents, organic solvents such as ketones and alcohols, or other chemicals), leak into the housing of the inmate phone 100 through a space between the switchhook 108 and the telephone casing 102. For example, the switchhook 108 depresses or pushes into a lower position in the telephone casing 102 when the handset 106 is placed in the phone cradle 110, which ultimately results in a space or gap between the switchhook 108 and the telephone casing 102. Through this space, fluids leak inside the housing of the inmate phone 100 and travel into the keypad 112 and the circuit board of the inmate phone 112. In some embodiments, inmate phones 100 are located outside and are exposed to fluids such as rain, in which rain water also enters the housing of the inmate phone 100 through the space between the switchhook 108 and the telephone casing 102. Exposure to such fluids causes corrosion of elements of the circuit board, such as copper and soldered components, and can short-circuit the circuit board immediately. In some embodiments, fluids that enter the telephone housing of the inmate phone 100 generate deposits that degrade the circuit board over time. Ultimately, exposing inmate phones 100 to fluids results in circuit degradation and failure of the keypad 112 in the inmate phone 100.

The keypad 112 for each inmate phone 100 needs to be replaced due to fluid exposure, and each correctional facility may have several inmate phones 100 that are out of service and unavailable for use by inmates due to keypad failure. In some embodiments, the keypad 112 is the most expensive component for a correctional facility to replace in an inmate phone 100. For example, one keypad unit can cost around $80, and the correctional facility also has to pay for the hours of installation and travel costs for a service technician or professional to travel to the correctional facility and install and replace the keypad unit 112 in each inmate phone 100. In some embodiments, a service technician has a long commute to a correctional facility (e.g., a one or two hour travel range for one way) and is able to enter a correctional facility and replace a keypad unit within 30 minutes. For example, the service technician may travel 100 miles in two hours for a round-trip to the correctional facility to replace an $80 keypad in half an hour, and the service technician may be paid $75 per hour and reimbursed 54 cents per mile.

By including travel costs, mileage reimbursement, unit costs, and installation, mileage, one keypad replacement can cost around $321.50 for the correctional facility. If the correctional facility or a jurisdiction that manages various correctional facilities has to replace around 108 keypads per year, keypad replacements can cost up to $34,722 per year for the correctional facility or jurisdiction. In addition to these significant costs, the correctional facility also loses potential revenue brought in by each inmate phone 100 due to keypad failure. For example, the keypad 112 needs to be replaced in inmate phones 100 after exposure to fluids, and the correctional facility will have one less inmate phone 100 that is functional and available for use by inmates. If several inmate phones 100 are out of service and unavailable for inmates to make calls, then the correctional facility loses thousands of dollars for each non-functional inmate phone.

Thus, described herein are new technologies and components to prevent keypad failure in inmate phones 100 and ultimately prevent loss of revenue for correctional facilities. In particular, this disclosure teaches a keypad fluid guard for deflecting fluids that migrate into inmate phones 100 through the switchhook 108 and preventing failure of the keypad 112 from exposure to fluids.

Inmate Phone with Installed Keypad Fluid Guard

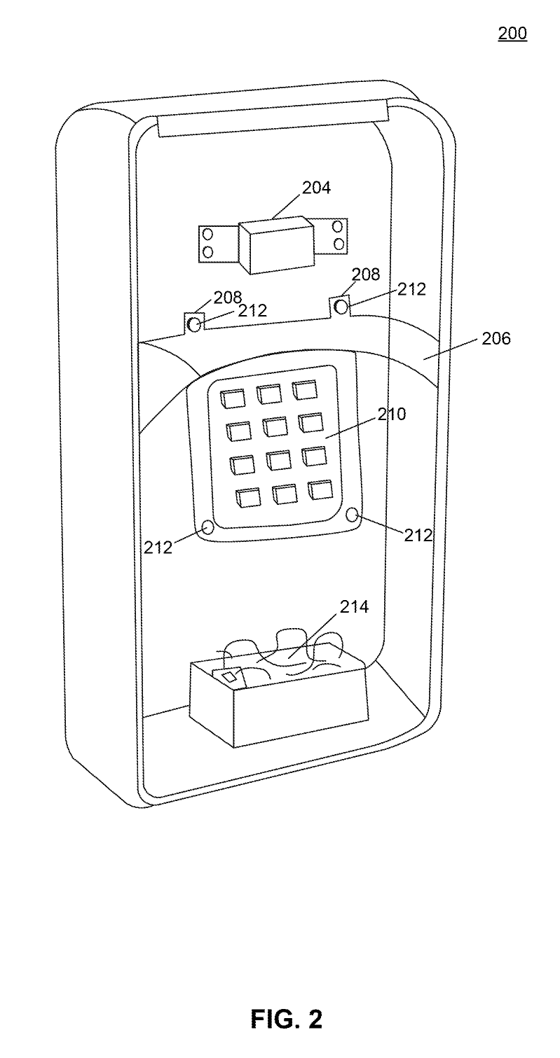

FIG. 2 illustrates a three-dimensional perspective view of a rear side of the telephone casing 200 of the inmate phone with an installed keypad fluid guard, according to embodiments of the present disclosure. The telephone casing 200 comprises a switchhook 204, a keypad fluid guard 206, a keypad 210, and circuitry 214. In some embodiments, telephone casing 200, switchhook 204, and keypad 210 represent exemplary embodiments of telephone casing 102, switchhook 108, and keypad 112 of FIG. 1, respectively. The keypad fluid guard 206 is installed in the telephone casing 102 in between the switchhook 204 and the keypad 210. In some embodiments, the keypad fluid guard 206 comprises a flexible material that is designed to deflect fluids from traveling through the switchhook 204 into the keypad 210 and the circuitry 214 of an inmate phone. For example, the keypad fluid guard 206 comprises a thin film composed of plastic, polyester, polycarbonate, Mylar, and/or another inexpensive material. In some cases, the keypad fluid guard 206 is flat and is bent at an angle during installation in the telephone casing 200 in order to deflect water.

In some embodiments, the keypad fluid guard 206 is installed in the telephone casing 200 of an inmate phone by using existing hardware in the inmate phone and/or without any modification to the inmate phone or the keypad 210 of the phone. For example, the keypad fluid guard 206 is installed above the keypad 210 by using a plurality of screws 212 of the keypad 210. Although only four screws 212 are shown in FIG. 2, it is understood that there can be any number of screws 212 in the telephone casing 200. In particular, the plurality of screws 212 is used to attach the keypad 210 in the telephone casing 200, and the keypad fluid guard 206 is also installed in the telephone casing 200 by using the same screws 212. The keypad fluid guard 206 further comprises a set of tabs 208 that allow for installation into the telephone casing 200 using the screws 212. In some embodiments, the length of the tabs 208 ranges from about 18-27 mm, whereas the width of the tabs 208 is about 14 mm. The tabs 208 are designed from the same material as the keypad fluid guard 206 and comprise openings (e.g., holes or slits) which allow for installation with the screws 212. In some embodiments, the openings in the tabs 208 comprise a rectangular shape with a length of about 15 mm and a width of about 6 mm.

In additional embodiments, the keypad fluid guard 206 is installed in the telephone casing 200 with another set of screws (not shown) that differ from the screws 212 of the keypad 210. For example, a different set of screws can be utilized with the tabs 208 to affix the keypad fluid guard 206 in the telephone casing 200, in which the keypad fluid guard 206 is positioned above the keypad 210. In some cases, the telephone casing 200 may have existing slots or openings such that the different set of screws can be utilized to affix the tabs 208 of the keypad fluid guard 206 to the telephone casing 200. By preventing modification of the telephone casing 200 and/or the keypad 210 for installation, the keypad fluid guard 206 is designed to be installed in an inmate phone without being permanently attached to the keypad 210. As opposed to applying sealants or other methods that would modify the keypad 210, the keypad fluid guard 206 allows for installation and protection of the keypad 210 without voiding the warrantee of the keypad 210 or inmate phone and without causing issues during refurbishment processes.

After installation in the telephone casing 200, the keypad fluid guard 206 redirects fluids that enter the inmate phone underneath the switchhook 204 to the sides and back of the telephone casing 200. For example, the keypad fluid guard 206 prevents fluids from reaching the keypad 210 by deflecting fluids away. In some embodiments, the keypad 210 further comprises a keypad circuit board, such as a printed circuit board (PCB), in addition to the keypad, and the keypad fluid guard 206 deflects fluids away in order to prevent fluids from directly dripping onto the keypad circuit board and damaging the keypad 210. For example, exposing the keypad circuit board to fluids causes corrosion of elements of the circuit board, such as copper and soldered components and ultimately results in failure of the keypad 210. Thus, the keypad fluid guard 206 deflects fluids, and fluids are diverted to the sides and the back of the telephone casing 200 away from the keypad 210 and the keypad circuit board. In some embodiments, the telephone casing 200 also comprises additional circuitry 214 below the keypad 210 and positioned at the bottom of the telephone casing 200. For example, the circuitry 214 comprises at least one circuit board with one or more integrated circuits (IC) chips, impedance balancing transformers, capacitors, resisters, soldered components, one or more batteries, pins, wiring, and the like.

The fluids deflected by the keypad fluid guard 206 are thus diverted to the bottom or base of the telephone casing 200 on the sides of the circuitry 214 to avoid damaging the inmate phone. In some embodiments, fluids that are deflected by the keypad fluid guard 206 run out of the base of the telephone casing 200 of the inmate phone and onto the ground. For example, the inmate phone (e.g., inmate phone 100) is located outside, and the fluids that are deflected by the keypad fluid guard 206 trickle onto the concrete from the base of the telephone casing 200 of the inmate phone. In another example, the inmate phone is located inside the correctional facility, such as in a designated area, and the fluids that are deflected by the keypad fluid guard 206 trickle onto the floor of the correctional facility from the base of the telephone casing 200 of the inmate phone. By redirecting fluids away from the keypad 210 and the circuitry 214 and out the base of the telephone casing 200, the keypad fluid guard 206 allows for easy cleanup of fluids from the inmate phone and protection of the inmate phone components.

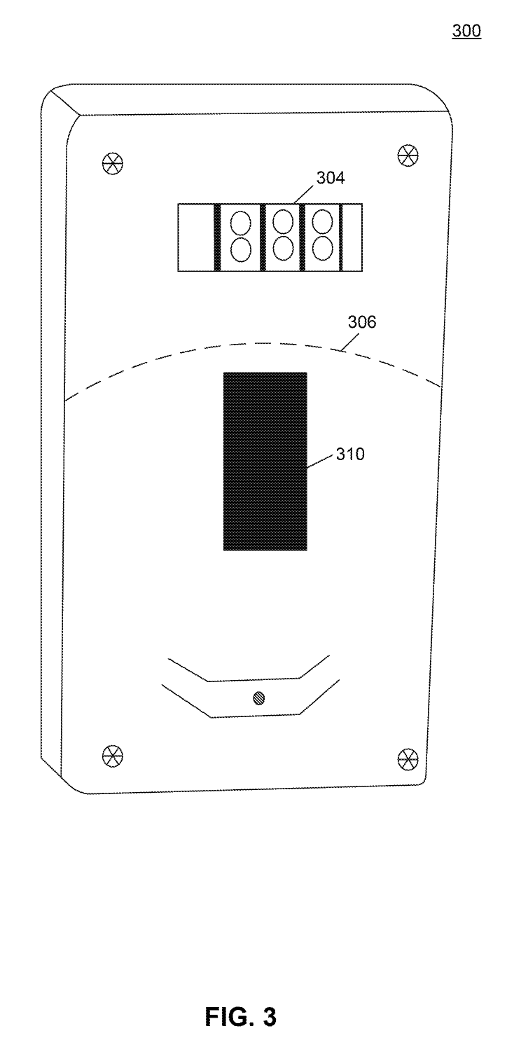

FIG. 3 illustrates a three-dimensional perspective view of the back plate 300 of the inmate phone, according to embodiments of the present disclosure. The back plate 300 comprises a switchhook area 304, a keypad fluid guard area 306, and a keypad area 310. In some embodiments, the back plate 300, switchhook area 304, keypad fluid guard area 306, and keypad area 310 represent exemplary embodiments of switchhook 204, keypad fluid guard 206, and keypad 210 of FIG. 2, respectively. In some embodiments, the switchhook area 304 comprises an area of the back plate 300 where the switchhook of the inmate phone is connected via the telephone casing (e.g., telephone casing 200). Similarly, the keypad area 310 comprises an area of the back plate 300 where the keypad of the inmate phone is connected via the telephone casing (e.g., telephone casing 200). In some embodiments, the keypad fluid guard area 306 comprises an area of the back plate 300 where the keypad fluid guard contacts the back plate 300 when installed in the telephone casing. For example, when the telephone casing with the installed keypad fluid guard is affixed to the back plate 300 of the inmate phone, the keypad fluid guard makes contact with the keypad fluid guard area 306 of back plate 300, as represented by the dotted line in FIG. 3. In some embodiments, the keypad fluid guard area 306 indicates that the keypad fluid guard is installed (e.g., in the telephone casing 200) in between the switchhook area 304 and the keypad area 310.

### Keypad Fluid Guard Configurations

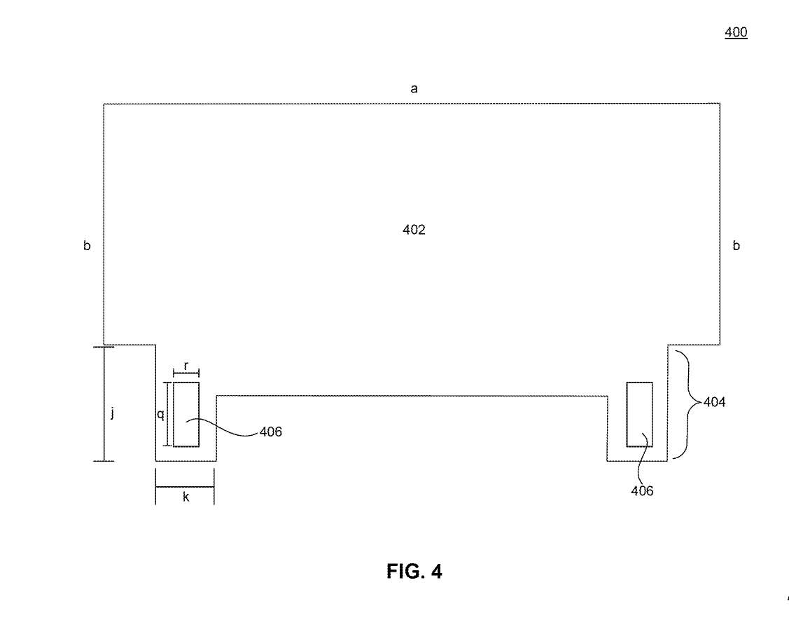

FIG. 4 illustrates a plan view of a template 400 for a keypad fluid guard, according to embodiments of the present disclosure. In some embodiments, the template 400 represents a pattern that is utilized for manufacturing keypad fluid guards (e.g., keypad fluid guard 206) which are provided to correctional facilities for installation into each inmate phone at the correctional facilities. The template 400 comprises a first portion 402 and a second portion 404. The first portion 402 of template 400 represents the portion of the keypad fluid guard that deflects fluids when installed in the telephone casing of an inmate phone. In particular, the first portion 402 of template 400 extends in a first plane in a direction along a width of the telephone casing of the inmate phone. For example, the first portion 402 is positioned horizontally in the telephone casing above the keypad and below the switchhook of the inmate phone when the keypad fluid guard is installed in the inmate phone.

In some embodiments, the first portion 402 comprises a front edge a and two side edges b. The front edge a represents the edge of the keypad fluid guard that comes into contact with the back plate of the inmate phone, and the side edges b represent the edges of the keypad fluid guard that comes into contact with the telephone casing of the inmate phone when the keypad fluid guard is installed in the inmate phone. For example, the front edge a of the keypad fluid guard makes contact with the keypad fluid guard area 306 in the back plate 300 of the inmate phone. In another example, the front edge a of the first portion 402 comprises a length of about 145 mm and the two side edges b of the first portion 402 comprise lengths of about 56 mm each. In some embodiments, the side edges b of the first portion 402 comprise the width of the keypad fluid guard, in which the width is approximately equal to a depth of a telephone casing of an inmate phone. The front edge a of the first portion 402 comprises the length of the keypad fluid guard, in which the length is approximately three times the width of the keypad fluid guard (e.g., side edge b). In some embodiments, the first portion 402 comprises a T-shape, in which the bottom overhangs of the first portion 402 comprise a length of about 26 mm.

The first portion 402 of template 400 is adjacent and connected to the second portion 404 of template 400. The second portion 404 of template 400 represents the portion of the keypad fluid guard that is utilized for mounting or installing the keypad fluid guard in the inmate phone. For example, the second portion 404 comprises a set of tabs that are affixed to the telephone casing of the inmate phone, in which each tab comprises a length j of about 27 mm and a width k of about 14 mm. In particular, the second portion 404 of template 400 extends in a second plane in a direction along a length of the telephone casing of the inmate phone. For example, the second portion 404 is positioned vertically in the telephone casing above the keypad and below the switchhook of the inmate phone when the keypad fluid guard is installed in the inmate phone. In some embodiments, the second portion 404 of template 400 is positioned in a second plane that is perpendicular to the first plane in which the first portion 402 of template 400 is positioned.

In particular, the second portion 404 further comprises a set of openings 406 in the keypad fluid guard that allow for the insertion of fasteners (e.g., screws) for the keypad fluid guard to be installed in the telephone casing of the inmate phone. For example, each opening 406 comprises a rectangular shape with a length q of about 15 mm and a width r of about 6 mm. In some embodiments, each opening 406 is positioned about 9 mm down from the top of the second portion 404 and about 3 mm above the bottom of the second portion 404. In some embodiments, the first portion 402 and the second portion 404 of the template 400 are formed from one continuous material, such as plastic, polyester, polycarbonate, Mylar, and/or another material. By utilizing an inexpensive material, correctional facilities may produce mass quantities of keypad fluid guards from the template 400 in a cost-effective manner for installation in hundreds and/or thousands of inmate phones.

In some embodiments, the keypad fluid guard produced from the template 400 is bent along the vertical axis of the template 400 in order to deflect fluids. For example, the keypad fluid guard is bent at an angle (e.g., bend angle) ranging from about 90 degrees to 150 degrees. The angle at which the keypad fluid guard is bent can be modified during installation, such as by physically manipulating the keypad fluid guard to bend more (e.g., by decreasing the bend angle) or bend less (e.g., by increasing the bend angle) and subsequently fastening the screws through the openings in the tabs of the keypad fluid guard. In some embodiments, the degree of the angle at which the first portion of the keypad fluid guard is bent affects the keypad fluid guard's efficacy in deflecting water. For example, a lower degree bend angle in the keypad fluid guard may deflect fluids more efficiently and/or quickly than a higher degree bend angle in the keypad fluid guard. In some embodiments, the keypad fluid guard curves upward at the bend angle, whereas in other embodiments, the keypad fluid guard curves downward at the bend angle. The direction at which the keypad fluid guard curves affects the amount of fluids that the keypad fluid guard deflects in the inmate phone.

In some embodiments, the template 400 for the keypad fluid guard is designed for different types and/or models of inmate phones, and the openings 406 of the template 400 are modified according to the type and model of inmate phone in which the keypad fluid guard is installed. For example, the various lengths of the first portion 402 and second portion 404 of the keypad fluid guard template 400, such as the lengths and widths of the openings 406) can be modified and adapted accordingly to fit into different inmate phone models. With customizable templates, correctional facilities can use customized keypad fluid guards that fit into inmate phones for preventing keypad fluid damage.

In additional embodiments, the keypad fluid guards are a cost-effective solution for mitigating the costs of replacing keypads in thousands of payphones at hundreds of correctional facilities. For example, each keypad fluid guard unit costs about $0.22 to manufacture (such as from template 400). If there approximately 3,590 inmate phones in correctional facilities in the state of California, then the total cost for keypad fluid guards for all the inmate phones in California costs about $789.80. This cost is significantly lower than the thousands of dollars that correctional facilities spend annually to replace keypads in inmate phones. In order to save further on installation costs, the keypad fluid guards can be installed in the inmate phones during new keypad installations, during new phone installations, or during preventative or routine maintenance checks. By installing keypad fluid guards, it is expected that keypad fluid guards can save correctional facilities up to $2.3 million dollars over the course of five years.

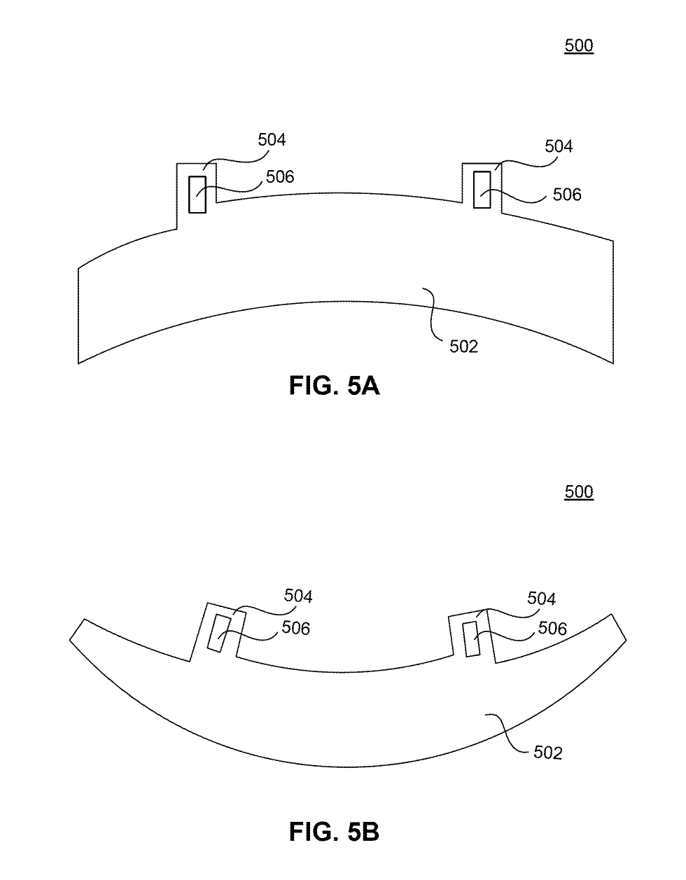

FIGS. 5A and 5B illustrate side views of a keypad fluid guard 500 in different configurations, according to embodiments of the present disclosure. In particular, FIG. 5A illustrates keypad fluid guard 500 in a first configuration, whereas FIG. 5B illustrates keypad fluid guard 500 in a second configuration. The keypad fluid guard 500 comprises a first portion 502, a set of tabs 504, and a set of openings 506. In some embodiments, the first portion 502, the set of tabs 504, and the set of openings 506 represent exemplary embodiments of first portion 402, second portion 404, and the set of openings 406 of FIG. 4, respectively. FIG. 5A illustrates the keypad fluid guard 500 in the first configuration in which the first portion 502 curves downward at the bend angle of the keypad fluid guard 500. In some embodiments, the first configuration is referred to as a concave-down configuration. The first configuration of the keypad fluid guard allows for fluids that enter an inmate phone through the switchhook to be deflected upward (e.g., to the sides of the telephone casing of the inmate phone and/or the bottom of the telephone casing of the inmate phone) away from the keypad and circuitry of the inmate phone.

FIG. 5B illustrates the keypad fluid guard 500 in the second configuration in which the first portion 502 curves upward at the bend angle of the keypad fluid guard 500. In some embodiments, the first configuration is referred to as a concave-up configuration. The second configuration of the keypad fluid guard to be deflected and/or redirected away from the keypad and circuitry of the inmate phone. In some cases, the second configuration of the keypad fluid guard allows for retention of fluids that enter the inmate phone. For example, if large volumes of fluids enter the inmate phone, the keypad fluid guard in the second configuration withstands and holds up the weight of the fluids in the inmate phone. Thus, the material used in the keypad fluid guard is flexible and designed to adapt to holding up different volumes of fluids that has entered the telephone casing of the inmate phone.

In some embodiments, the second configuration of the keypad fluid guard allows for deflection of larger amounts or volumes of fluid than the fluid volumes deflected by the first configuration of the keypad fluid guard. For example, the upward curve of the second configuration of the keypad fluid guard allows for the guard to hold up larger volumes of fluids than the downward curve of the first configuration of the keypad fluid guard. In some embodiments, the weight of fluids in an inmate phone causes the keypad fluid guard to bend or flex from the first configuration to the second configuration to hold the fluids up and prevent the fluids from reaching the keypad and circuitry of the inmate phone.

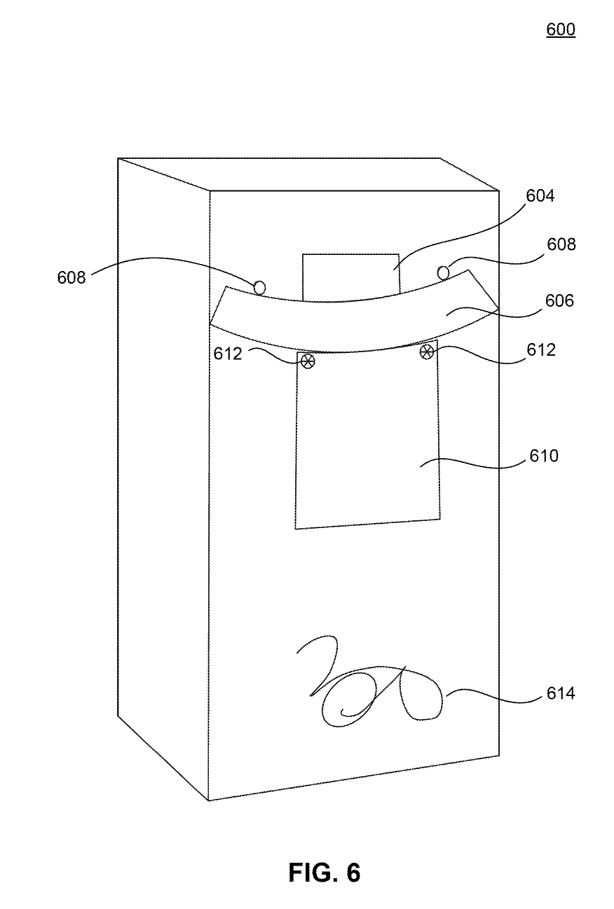

FIG. 6 illustrates a three-dimensional perspective view of the telephone casing 600 of an inmate phone with the keypad fluid guard installed in a second configuration, according to embodiments of the present disclosure. The telephone casing 600 comprises a switchhook 604, a keypad fluid guard 606, a keypad 610, and circuitry 614. In some embodiments, telephone casing 600, switchhook 604, keypad 610, and circuitry 614 represent exemplary embodiments of telephone casing 200, switchhook 204, keypad 210, and circuitry 214 of FIG. 2, respectively. In some embodiments, the keypad fluid guard 606 is installed in the telephone casing 600 in between the switchhook 604 and the keypad 610 in a concave-up configuration in which the keypad fluid guard 606 is curved upward. This configuration differs from the concave-down configuration of the keypad fluid guard 206 as illustrated in FIG. 2, in which the keypad fluid guard 206 curves downward.

In some embodiments, the keypad fluid guard 606 is configured to deflect fluids from traveling through the switchhook 604 into the keypad 610 and the circuitry 614 of the inmate phone. In addition to deflecting fluids, the keypad fluid guard 606 also retains or holds up fluids and is designed to adapt to holding up different volumes of fluids that have entered the telephone casing 600. As illustrated in FIG. 6, the keypad fluid guard 606 further comprises a set of tabs 608 that allow for installation into the telephone casing 600. Each tab 608 includes an opening (e.g., a hole or slit) which allows for the keypad fluid guard 606 to be affixed in the telephone casing 600. In particular, the keypad fluid guard 606 is installed above the keypad 610 by using a plurality of screws 612 of the keypad 610. In some embodiments, the set of tabs 608 and the plurality of screws 612 represent exemplary embodiments of the set of tabs 208 and the plurality of screws 212 of FIG. 2, respectively.

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the disclosure should not be limited by any of the above-described exemplary embodiments, but should be defined only in accordance with the following claims and their equivalents.

1. A keypad fluid guard installed in an inmate phone, the inmate phone having a back plate, a telephone casing affixed to the back plate, a switchhook, and a keypad disposed below the switchhook, the keypad fluid guard comprising:
a first portion that extends in a first plane in a direction along a width of the telephone casing of the inmate phone; and
a second portion that extends in a second plane in a direction along a length of the telephone casing, wherein the second portion comprises a set of tabs for mounting the first portion of the keypad fluid guard in between the switchhook and the keypad of the inmate phone, and wherein the keypad fluid guard is positioned on the inside of the telephone casing of the inmate phone.

2. The keypad fluid guard of claim 1, wherein the keypad fluid guard is positioned between the switchhook and the keypad on the inside of the telephone casing.

3. The keypad fluid guard of claim 1, wherein the first portion of the keypad fluid guard deflects fluids that enters the inmate phone through a space between the switchhook and the telephone casing.

4. The keypad fluid guard of claim 1, wherein the set of tabs comprise rectangular openings configured to receive fasteners of the keypad of the inmate phone.

5. The keypad fluid guard of claim 4, wherein the fasteners of the keypad affix the second portion of the keypad fluid guard and the keypad to the telephone casing of the inmate phone.

6. The keypad fluid guard of claim 1, wherein the first portion and the second portion comprise a continuous material, and wherein the first portion is bent at a bend angle ranging from 90 degrees to 150 degrees.

7. The keypad fluid guard of claim 6, wherein the first portion of the keypad fluid guard curves upward at the bend angle.

8. The keypad fluid guard of claim 6, wherein the first portion of the keypad fluid guard curves downward at the bend angle.

9. The keypad fluid guard of claim 1, wherein the first portion and the second portion comprise at least one of plastic, polyester, polycarbonate, or Mylar.

10. The keypad fluid guard of claim 1, wherein the second plane is perpendicular to the first plane.

11. A keypad fluid guard comprising:
a first portion with a width approximately equal to a depth of a telephone casing of an inmate phone and a length that is three times the width; and
a second portion comprising a set of tabs that is connected to the first portion, wherein the keypad fluid guard is configured to be positioned on the inside of the telephone casing of the inmate phone.

12. The keypad fluid guard of claim 11, wherein the first portion of the keypad fluid guard deflects fluids that enter the inmate phone.

13. The keypad fluid guard of claim 11, wherein the set of tabs are configured to mount to a keypad of the inmate phone.

14. The keypad fluid guard of claim 13, wherein the set of tabs comprise rectangular openings that configured for receiving fasteners of the keypad of the inmate phone.

15. The keypad fluid guard of claim 14, wherein the fasteners of the keypad affix the second portion of the keypad fluid guard and the keypad to the telephone casing of the inmate phone.

16. The keypad fluid guard of claim 11, wherein the first portion is bent at a bend angle ranging from 90 degrees to 150 degrees.

17. The keypad fluid guard of claim 16, wherein the first portion of the keypad fluid guard curves upward at the bend angle.

18. The keypad fluid guard of claim 16, wherein the first portion of the keypad fluid guard curves downward at the bend angle.

19. The keypad fluid guard of claim 11, wherein the first portion and the set of tabs comprise at least one of plastic, polyester, polycarbonate, or Mylar.

20. A method for installing a keypad fluid guard, the method comprising:
providing the keypad fluid guard in a telephone casing of an inmate phone, wherein the keypad fluid guard comprises a set of tabs with openings;
positioning the keypad fluid guard in between a switchhook and a keypad on the inside of the telephone casing of the inmate phone; and
mounting the keypad fluid guard to the telephone casing of the inmate phone by affixing a set of fasteners through the openings in the set of tabs of the keypad fluid guard.
